(19) United States
(12) Patent Application Publication
(10) Pub. No.: US 2012/0007350 A1
(43) Pub. Date: Jan. 12, 2012

(54) Pad of connected rubber body and metal plate and method of manufacturing the same

(76) Inventor: Ming-Ling WANG, Huatan Township (TW)

(21) Appl. No.: 13/118,231

(22) Filed: May 27, 2011

(30) Foreign Application Priority Data
Jul. 6, 2010 (TW) 099212910

(51) Int. Cl. B62D 25/18; B60N 3/04; B32B 15/06; B29C 45/14; B32B 3/06

(52) U.S. Cl. 280/847; 156/245; 428/139

(57) ABSTRACT

A pad of connected rubber body and metal plate and the method of manufacturing the same are disclosed. The rubber body is embedded with a metal plate whose rim is formed with through holes. The rubber body is formed with a recess at the embedding position of the metal plate, the recess having an embedding groove on the side. The through holes of the metal plate are in the embedding groove. The rubber body is formed with a positioning post for and going through each of the through holes. The rubber body and the metal plate are thus integrally connected while formation.

### BACKGROUND OF THE INVENTION

1. Field of Invention

The invention relates to a pad and, in particular, to a pad of connected rubber body and metal plate and the method of manufacturing the same.

2. Related Art

When a motorcycle or car runs on a road, people usually use fenders behind tires to prevent mud from being splashed all over the places. Since mud splashing becomes more serious for large-diameter tires, such as those for trucks and buses, their fenders have to be longer in order to block more mud.

The fender in the prior art usually has the structure of a surface layer connected to the surface of a rubber pad. The surface layer can be printed with a pattern as decoration. It can also be a metal thin film for reflecting light during nighttime. However, the surface layer and the pad have to be connected by sewing or gluing. This is more complicated and needs to be improved.

### SUMMARY OF THE INVENTION

One objective of the invention is to provide a pad of connected rubber body and metal plate and the method of manufacturing the same. When the rubber is formed, the pad is directly connected with the metal plate, without extra work. The invention thus makes the manufacturing of the pad more efficient.

Another objective of the invention is to use the exposed surface of the metal plate on the rubber as a mirror when the pad is used as a fender. In this case, the mirror can reflect light from cars behind, achieving the goal of notifying other drivers about the existence and distance of the vehicle.

To achieve the above-mentioned objectives, a rubber body is embedded with at least one metal plate with an exposed surface. The metal plate has several through holes in the longitudinal direction on the edge thereof. The rubber body is formed with a recess for the metal plate to embed therein. The rubber body has an embedding groove for the rim of the metal plate to be inserted into. The sidewall of the embedding groove of the rubber body is separable from the metal plate. The through holes of the metal plate are in the embedding groove. A positioning post is formed in each of the through hole for the metal plate and the rubber body to be integrally formed together.

The pads are used as fenders of a vehicle and disposed behind tires. The metal plate is disposed on the lower section behind the rubber body, and functions as a plat mirror on the exposed surface of the rubber body.

The disclosed pad is formed with a mold by pressing. The mold includes an upper mold and a lower mold. When the upper mold and the lower mold are combined, there is a mold cavity for forming the rubber body. Before the upper mold and the lower mold are combined, the metal plate is disposed in a lower mold cavity on the lower mold. After the upper mold and the lower mold are combined, rubber is injected into the mold. The rubber body is then formed after the mold is opened. In this case, the rubber body is formed with the recess and the embedding groove at the position of the metal plate. The through holes of the metal plate are formed with positioning posts in order to connect the rubber body with the metal plate as a single body.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a three-dimensional view of the pad as a footpad according to a first embodiment of the invention;

FIG. 2 is a planar view of the pad in the first embodiment;

FIG. 3 is a cross-sectional view of a metal plate embedded in the embedding groove according to the first embodiment;

FIG. 4 is a cross-sectional view of the mold for the first embodiment;

FIG. 5 is a cross-sectional view of the mold for the first embodiment filled with rubber;

FIG. 6 is a cross-sectional view of the pad of the first embodiment;

FIG. 7 is a three-dimensional view of the pad as a fender according to a second embodiment of the invention; and

FIG. 8 is a schematic view of installing the pad of the second embodiment behind a tire.

### DETAILED DESCRIPTION OF THE INVENTION

The present invention will be apparent from the following detailed description, which proceeds with reference to the accompanying drawings, wherein the same references relate to the same elements.

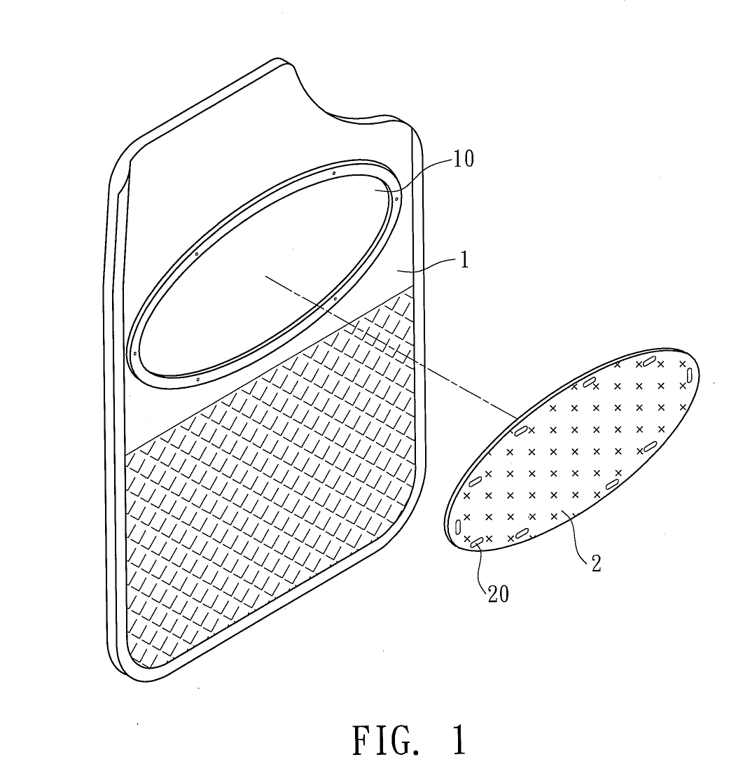

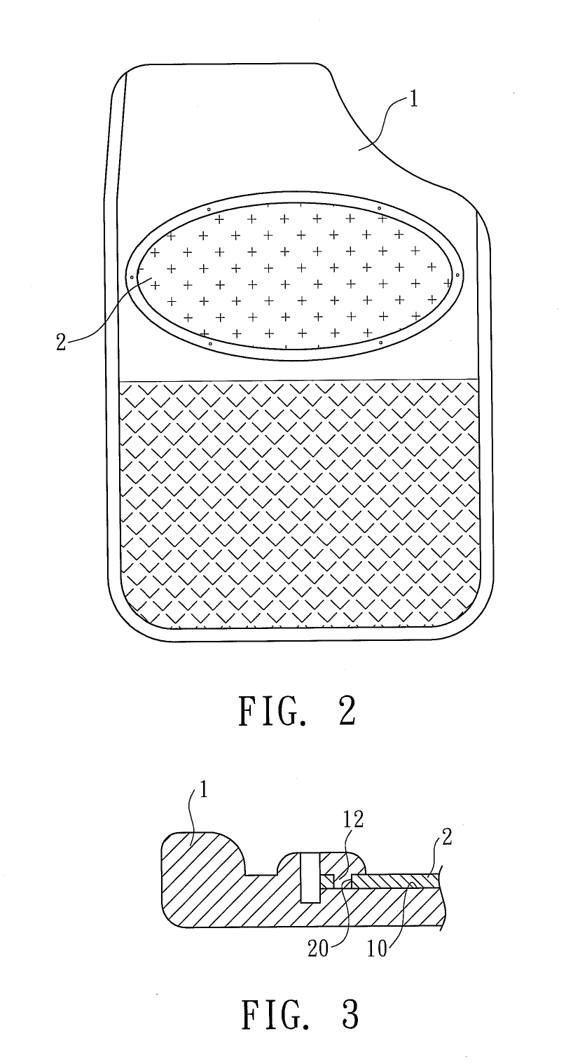

Please refer to FIGS. 1 to 6 for a first embodiment of the invention, in which a pad of connected rubber body and metal plate is used as a footpad in vehicles. The pads can be disposed in front of seats in a vehicle. As shown in FIGS. 1 to 3, the pad includes a rubber body 1 and an embedded metal plate 2. The metal plate 2 has several through holes 20 along the rim thereof. Each of the through holes 20 goes through the metal plate 2 in the longitudinal direction. The rubber body 1 is formed with a recess 10 at the embedding position of the metal plate 2. The recess 10 in this embodiment is formed in the lower portion in the back of the rubber body 1 for accommodating the metal plate 2. The rubber body 1 is further formed with an embedding groove 11 on the sidewall of the recess 10 for the metal plate 2 to be inserted therein. The sidewall of the embedding groove 11 of the rubber body 1 is separable from the metal plate. The through holes 20 of the metal plate 2 are in the embedding groove 11. The rubber body 1 is formed with a positioning post 12 going through each of the through holes 20, so that the rubber body 1 and the metal plate 2 are integrally connected while formation.

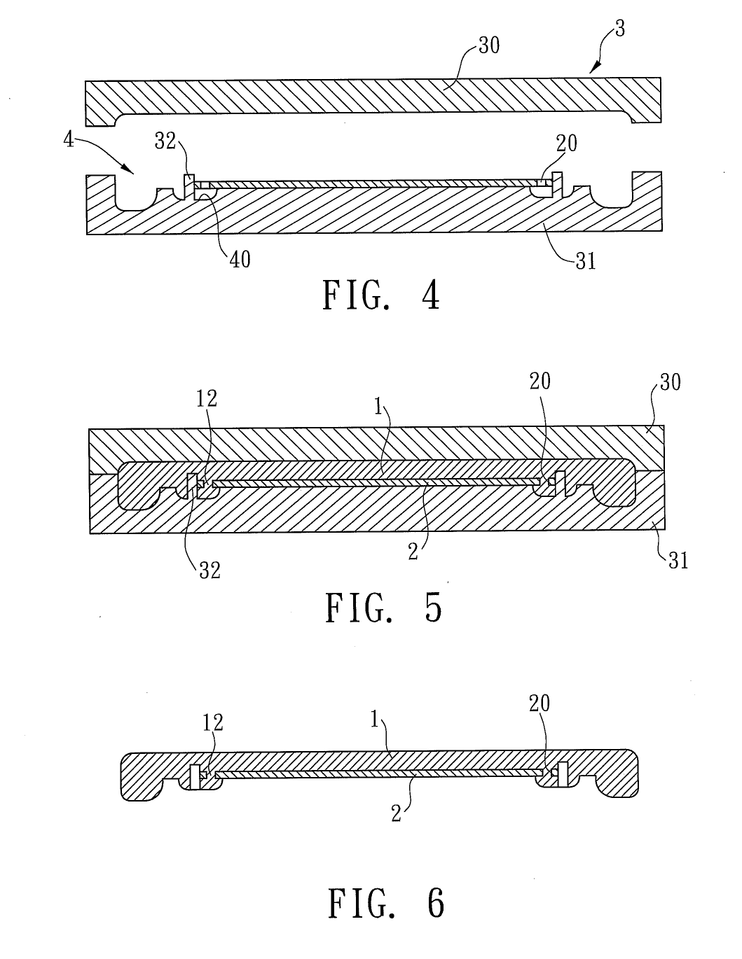

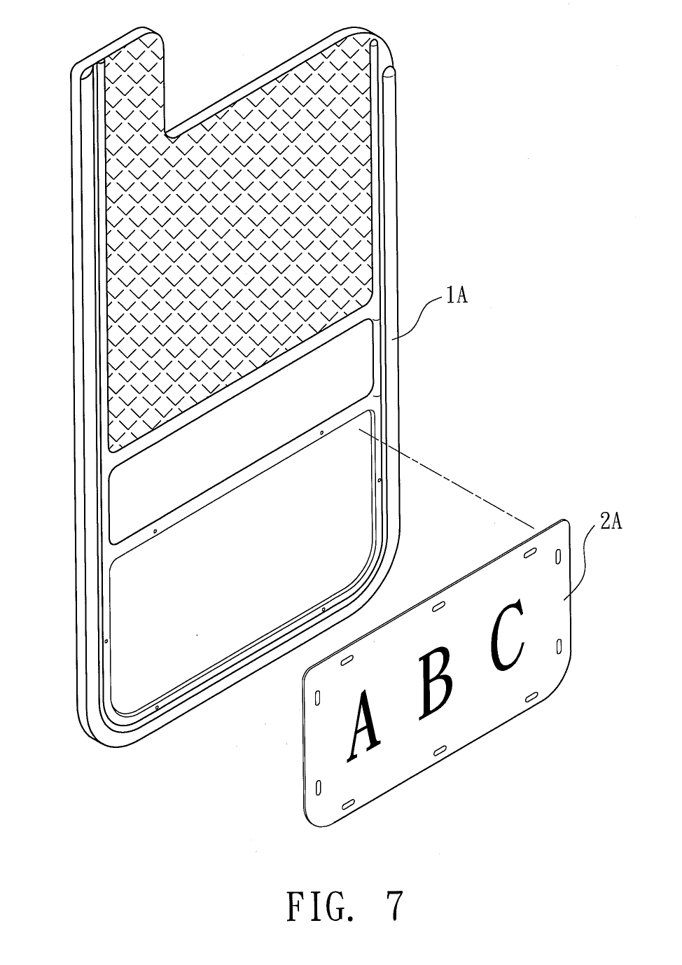

As shown in FIGS. 4 to 6, the pad in this embodiment is formed by pressing using a mold 3. The mold 3 includes an upper mold 30 and a lower mold 31. When the upper mold 30 and the lower mold 31 are connected, a mold cavity 4 for forming the rubber body 1 is pre-formed. As shown in FIG. 4, the metal plate 2 is disposed in the lower mold cavity 40 of the lower mold 31 before the upper mold 30 and the lower mold 31 are connected. Both sides of the metal plate 2 on the lower mold 31 have protruding posts 32 to prevent the metal plate 2 from shifting sideways. As shown in FIG. 5, rubber is injected after the upper mold 30 and the lower mold 31 are connected to form the rubber body 1. After the upper mold 30 and the lower mold 31 are opened, the rubber 1 as in FIG. 6 is formed. In this case, the rubber body 1 is formed with the recess 10 and the embedding groove 11 at the position of the metal plate 2. The through holes 20 of the metal plate 2 are formed with positioning posts 12 to combine the rubber body 1 and the metal plate 2 as a single body. Therefore, the metal plate 2 in the mold 3 is positioned by the positioning posts 12 that go through the through holes 20. The metal plate 2 is thus firmly positioned on the rubber body 1 without shifting. The metal plate 2 and the rubber body 1 are combined as a single body. The surface of the rubber body 1 can be decorated with a pattern by having a corresponding pattern in the mold cavity of the mold 3.

Due to the protruding posts 32 on the sides, the metal plate 2 in the lower mold 31 is prevented from shifting. The metal plate 2 is thus positioned in the lower mold, instead of deviating when the mold is moved or injected with rubber. Therefore, the metal plate 3 is ensured at the predetermined position in each rubber injection. The rubber can thus be injected into the through holes 20 along the rim of the metal plate 2. This ensures that the metal plate 2 and the rubber body 1 are firmly connected as a single body.

According to the above description, it is seen that the advantages of the invention are the following. When the rubber body 1 is formed, it is integrally formed with the metal plate 2. This procedure saves extra time for combining the rubber body 1 and the metal plate 2. And the metal plate 2 is firmly connected to the rubber body 1. The production is thus more efficient.

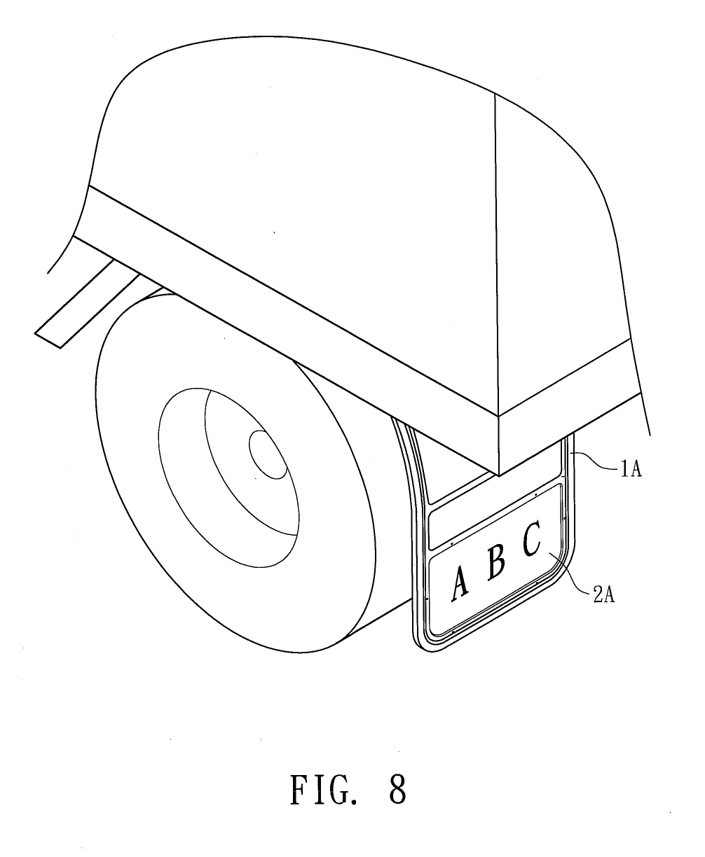

The invention, of course, has many other embodiments that only differ from the disclosed one in details. Please refer to FIG. 7 for a second embodiment of the invention. The pad in this embodiment is used as a fender of vehicles. The pad is disposed behind a tire, as shown in FIG. 8. As in the first embodiment, a metal plate 2A with an exposed surface is embedded in a rubber body 1A. The metal plate 2A has a flat mirror-like surface and exposes from the rubber body 1.

When the pad is used as a fender, the exposed flat mirror-like surface of the metal plate 2 can reflect light from other vehicles in the back. This is particularly useful in a dark environment and/or when the visibility is bad. By reflecting the light from vehicles behind, the drivers in those vehicles can know the existence of the vehicle in the front and judge the distance to it according to the reflection. This achieves the goal of driving safety.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A pad of connected rubber body and metal plate comprising a rubber body embedded with a metal plate with at least one exposed surface; wherein the metal plate is formed with a plurality of longitudinal through holes along the rim thereof; the rubber body is formed with a recess for accommodating the metal plate at the embedding position of the metal plate; the recess is further formed with an embedding groove for the metal plate to be inserted therein, the sidewall of the embedding groove being separable from the metal plate and the through holes of the metal plate being in the embedding groove; and the rubber body is formed with a positioning post for and going through each of the through holes so that the rubber body and the metal plate are integrally connected during formation.

2. The pad of connected rubber body and metal plate of claim 1 used as a vehicle fender, wherein the pad is disposed behind a tire of the vehicle, the metal plate is on the lower portion behind the rubber body, and the exposed surface of the metal plate is flat and mirror-like.

3. The pad of connected rubber body and metal plate of claim 1 used as a vehicle footpad, wherein the pad is disposed in front of seats of a vehicle.

4. A method of manufacturing the pad of connected rubber body and metal plate of claim 1, comprising the steps of:
preparing a mold for forming the pad by pressing, the mold including an upper mold and a lower mold with a mold cavity for forming the rubber body formed when the upper and lower molds are connected;
placing a metal plate in a lower mold hole of the lower mold, the sides of the metal plate on the lower mold being formed with protruding posts to prevent the metal plate from shifting;
injecting rubber after the upper mold and the lower mold are connected;
wherein the rubber body is obtained after the upper mold and the lower mold are opened, the rubber body is formed with the recess and the embedding groove at the position of the metal plate, and the through holes on the metal plate are formed with positioning posts to integrally combine the rubber body and the metal plate.
